(19) United States
(12) Patent Application Publication
(10) Pub. No.: US 2014/0127580 A1
(43) Pub. Date: May 8, 2014

(54) STRUCTURES INCLUDING POROUS GERMANIUM, METHODS OF MAKING, AND METHODS OF USE THEREOF

(71) Applicant: UNIVERSITY OF FLORIDA RESEARCH FOUNDATION, INC., Gainsville, FL (US)

(72) Inventors: Kevin Scott Jones, Archer, FL (US); Bradley Robert Yates, Gainesville, FL (US); Blake Leonardl Darby, Gainesville, FL (US)

(21) Appl. No.: 14/112,262

(22) PCT Filed: Jun. 26, 2012
(86) PCT No.: PCT/US12/44139

§ 371 Date: Oct. 17, 2013

Related U.S. Application Data
(60) Provisional application No. 61/502,451, filed on Jun. 29, 2011.

(51) Int. Cl. H01M 4/38; H01M 4/1395; H01M 4/04

(52) U.S. Cl. CPC H01M 4/38; H01M 4/0402; H01M 4/1395
USPC 429/220; 429/218.1; 429/221; 429/223; 427/531; 427/528

(57) ABSTRACT

Embodiments of the present disclosure provide for a structure, methods of making the structure, methods of using the structure, and the like. In particular, the structure includes a porous germanium layer, where the porous germanium layer includes a porous network that improves the performance of the structure.

### CROSS-REFERENCE TO RELATED APPLICATION

This application claims priority to U.S. provisional application entitled “STRUCTURES INCLUDING POROUS GERMANIUM, METHODS OF MAKING, AND METHODS OF USE THEREOF,” having Ser. No. 61/502,451, filed on Jun. 29, 2011, which is entirely incorporated herein by reference.

### BACKGROUND

Lithium ion batteries (LIB) have significant advantages over conventional batteries in that they provide a high volumetric and gravimetric energy density, while also being safe and environmentally friendly. Because of these advantages, LI Bs have numerous applications in portable electronics, MEMS devices, RFID tags, implantable medical devices, and even electric vehicles. LIBs have 3 basic components: consisting of an anode, electrolyte, and cathode as seen in FIG. 2. The present disclosure addresses the anode component. Commercial LIBs contain a graphite anode, which has a relatively low theoretical capacity of 372 mAh/g. Germanium (Ge) is an alternative anode material, which has a theoretical capacity of 1625 mAh/g, but suffers from volumetric expansion upon lithiation. This leads to capacity fade over repeated cycling. The present disclosure discusses methods to prepare Ge anodes to achieve high, stable capacities for extended cycling.

### SUMMARY

Embodiments of the present disclosure provide for a structure, methods of making the structure, methods of using the structure, and the like. In particular, the structure includes a porous germanium layer, where the porous germanium layer includes a porous network that improves the performance of the structure.

An embodiment of the structure, among others, includes: a substrate having a porous germanium layer disposed on the substrate. In an embodiment, the germanium layer is amorphous or polycrystalline. In an embodiment, the germanium has one or more of the following: a pore fraction of about 25 to 75, a pore volume of about 25 to 75, or a pore diameter of about 50 nm to 5 microns.

An embodiment of the method of making a structure, among others, includes: providing a structure having a germanium layer disposed on a substrate; and forming a porous germanium layer by subjecting the structure to Ge ion implantation. In an embodiment, the method also includes forming includes using an implant energy of about 100 keV to 300 keV and a dose of about 2 E¹⁵ to 1 E¹⁷ of Ge⁺, wherein the germanium layer has a thickness of about 150 to 250 nm.

### BRIEF DESCRIPTION OF THE DRAWINGS

Many aspects of the disclosed devices and methods can be better understood with reference to the following drawings. The components in the drawings are not necessarily to scale, emphasis instead being placed upon clearly illustrating the relevant principles. Moreover, in the drawings, like reference numerals designate corresponding parts throughout the several views.

FIG. 1 illustrates a cross-sectional transmission electron microscopy image of Ge deposited to a thickness of 240 nm on a Ni substrate and subsequently implanted with 260 keV 1×10¹⁶ Ge⁺/cm² displaying the porous nature of the film. The Pt layer is not functional, but rather necessary for the image preparation.

FIG. 2 illustrates a schematic displaying the basic structure of a lithium ion battery cell. For an embodiment, the porous Ge electrode would act as the anode due to its electrochemical potential with repect to Li/Li⁺. The electrolyte used could be either liquid or solid-state depending on the intended use of the cell.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed. Terms defined in references that are incorporated by reference do not alter definitions of terms defined in the present disclosure or should such terms be used to define terms in the present disclosure they should only be used in a manner that is inconsistent with the present disclosure.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, inorganic chemistry, material science, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in atmosphere. Standard temperature and pressure are defined as 25° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Definitions

The phrase “pore fraction” refers to the volume fraction of a layer (e.g., the Ge layer) that is porous, divided by the total volume of a layer (e.g., the Ge layer).

The phrase “pore volume” refers to the total volume occupied by pores. The phrase “pore diameter” (or dimensions) refers to the average diameter (or dimension) of the pores, assuming a spherical shape in which the average pore diameter is able to correspond to an approximate volume.

### Discussion

Embodiments of the present disclosure provide for a structure, methods of making the structure, methods of using the structure, and the like. In particular, the structure includes a porous germanium layer, where the porous germanium layer includes a porous network that improves the performance of the structure.

In an embodiment the structure can be used as an anode in a lithium ion battery, used in a capacitor structure or a photovoltaic cell. An advantage of using the structure in a lithium ion battery includes an increased surface area to volume ratio that improves electrochemical cycling characteristics by decreasing the capacity fade. The structure also can increase the lithiation and delithiation kinetics by decreasing transfer lengths leading to greater energy transfer rates of the lithium ion battery.

An additional advantage of the porous germanium structure in a lithium ion battery includes an increased pore volume, allowing for facile volume expansion and decreased strain upon lithiation. These characteristics can help to improve contact with the anode and current collector during repeated cycling.

In an embodiment, the structure includes a substrate having a porous germanium layer disposed on the substrate. In an embodiment, the porous germanium layer is created by ion implantation of either bulk or deposited Ge and/or SiGe on a substrate (See the Example). In an embodiment, a layer of germanium and/or silicon can be deposited on the porous germanium layer.

In an embodiment, the substrate can be a material such as Al, Ni, Fe, Cu, stainless steel, and the like. In an embodiment, the substrate can be a non-lithiating material or metal that is used as an electrode substrate for lithium-ion battery cells. In a particular embodiment, the substrate is Ni. In an embodiment, the substrate can have a thickness of about 0.2 μm to 5 mm or about 25 μm to 500 μm.

In an embodiment, the porous germanium layer disposed on the substrate is amorphous, but may be crystallized using appropriate deposition or post-deposition processing techniques or anneals. In an embodiment, the porous germanium layer can have a thickness of about 50 nm to 5 μm or about 100 nm to 1 μm. The areal dimensions of the porous germanium layer depend on the size of the sample but could be about 1 E⁻⁸ cm² to greater than about 1000 cm², and selection of these dimensions can vary depending upon the desired use.

In an embodiment, the porous germanium layer can include another material such as silicon to add or change a characteristic of the porous germanium layer. For example, inclusion of silicon in the porous germanium layer can increase the specific capacity (mAh/g) of the porous layer. In addition to changing the specific capacity of the electrode, electrochemical rates can also be tailored through the implementation of silicon in the microstructure.

In an embodiment, the porous germanium layer can have various characteristics (e.g., capacity, pore fraction, pore volume, coulombic efficiency, and the like) such as those described herein. In an embodiment, the porous germanium layer has a capacity of about 1000 milliamp hour/gram of porous germanium or more, about 1100 milliamp hour/gram of porous germanium or more, or about 1200 milliamp hour/gram of porous germanium or more. In an embodiment, the porous germanium layer can have a capacity of about 1 to 1625, about 500 to 1625, or about 500 to 1200, milliamp hour/gram of porous germanium. In an embodiment, the porous germanium layer has a pore fraction of about 1% to 90% or about 25% to 75%. In an embodiment, the porous germanium layer has a pore volume of about 1% to 90% or about 25% to 75%. In an embodiment, the porous germanium can have a coulombic efficiency of about 1-100% or about 80-100%. In an embodiment, the porous germanium layer can extend the entire thickness of the germanium layer or a fraction (e.g., less than 90%, less than 75%, less than 60%, of the thickness) of the Ge layer thickness. Schematics and images of the porous germanium layer are provided in the Example.

In an embodiment, the method for forming the structure that includes the porous germanium layer can include providing a substrate, such as one of those described herein. In an embodiment, an amorphous or poly-crystalline layer of germanium can be formed on the substrate through evaporation, sputtering, or chemical vapor deposition of the germanium. Subsequently, the germanium (or SiGe) layer is subjected to Ge⁺ ion implantation. In an embodiment, other ions can be used to create the porous structure in Ge or SiGe. In an embodiment, the temperature during the Ge⁺ion implantation is about 20° C. to 30° C. and the pressure is about 1 E⁻⁶ torr to 1 E⁻⁸ torr. In an embodiment, the implant energy can be about 1 keV to 5 MeV, or about 100 keV to 300 keV. The implant energy and/or the dose amount can depend upon the thickness of the germanium layer, the desired pore size and depth in the germanium layer and the implant species.

Following the germanium deposition, a brief anneal of 250° C. to 400° C. may be used to create a nickel germanide at the nickel-germanium interface to promote chemical adhesion of the deposited germanium layer to the nickel substrate. In another embodiment, a layer of germanium and/or silicon can be deposited on top of the porous germanium layer, which can be performed before and/or after annealing.

Although not intending to be bound by theory, the implantation process may increase the adhesion of the Ge to the substrate through ion beam mixing of the interface, and the porous Ge may alter the evolution of the Ge film upon battery cycling such as to reduce the fading associated with film delamination.

In an embodiment, the germanium layer is about 240 nm, the implant energy is about 130 keV, and the dose is about 1×10¹⁶ Ge/cm², and the thickness that the porosity extends is about 100% of the thickness (about 250 nm) of the germanium layer (after swelling of the germanium layer, which occurs during implantation). The implant energy, the dose amount, and the like can be varied depending upon the other variables (e.g., such as the germanium layer thickness) to produce the desired porous germanium layer.

In an embodiment, the morphology of the porous germanium structure can be tailored based on the starting substrate conditions, implant temperature, and/or implanted dose. The substrate conditions yield differing pore morphologies following high-dose implantation where high-density crystalline or polycrystalline structure yields columnar pores following where lower-density amorphous films including microscopic or submicroscopic pores yields a microstructure of spherical or ‘spongy’ pores.

### EXAMPLE

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

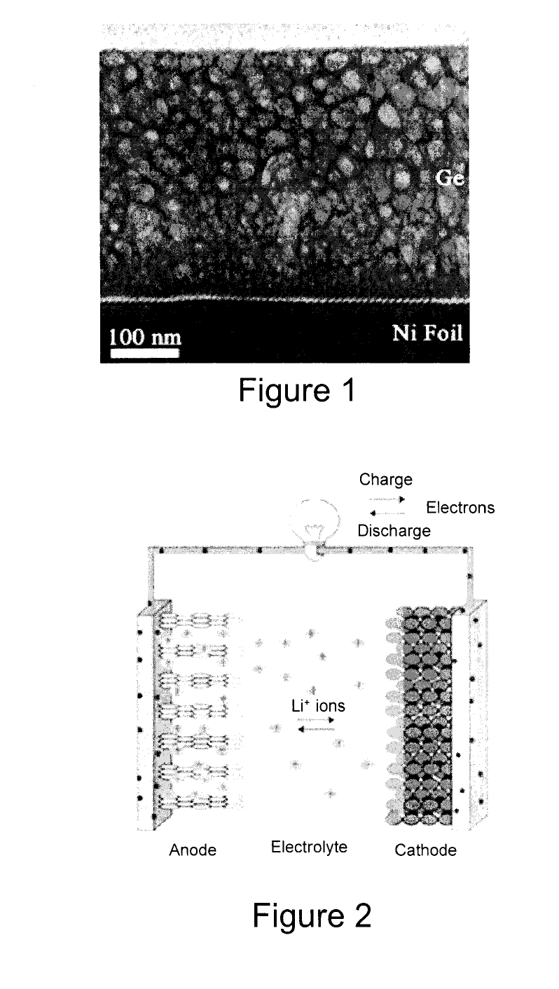

FIG. 1 illustrates a cross-sectional transmission electron microscopy image of Ge sputter deposited to a thickness of 240 nm on a Ni substrate and subsequently implanted with 260 keV 1×10¹⁶ Ge/cm²displaying the porous nature of the film. The C layer is not functional, but rather necessary for the image preparation.

FIG. 2 illustrates a schematic displaying the basic structure of a lithium ion cell. For an embodiment, the porous Ge electrode would act as the anode due to its electrochemical potential with repect to Li/Li⁺. The electrolyte used could be either liquid or solid-state depending on the intended use of the cell.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to the values and/or measuring techniques. In addition, the phrase “about ‘x’ to ‘y’” includes “about ‘x’ to about ‘y’”.

Many variations and modifications may be made to the above-described embodiments. All such modifications and variations are intended to be included herein within the scope of this disclosure and protected by the following claims.

At least the following is claimed:

1. A structure, comprising:
a substrate having a porous germanium layer disposed on the substrate.

2. The structure of claim 1, wherein the substrate is a material selected from the group consisting of: Al, Ni, Fe, Cu, stainless steel, a non-lithiating material, and a combination thereof.

3. The structure of claim 1, wherein the germanium layer has a thickness of about 50 nm to 4 micrometers.

4. The structure of claim 1, wherein the germanium layer is amorphous or polycrystalline.

5. The structure of claim 1, wherein the germanium layer includes silicon.

6. The structure of claim 1, wherein the porosity extends about 50% or more of the thickness down into the porous germanium layer.

7. The structure of claim 1, wherein the porous germanium layer has a capacity of about 1000 milliamp hour/gram of porous germanium or more.

8. The structure of claim 1, wherein the porous germanium layer has a coulombic efficiency of about 80-100%.

9. The structure of claim 1, wherein the germanium has one or more of the following: a pore fraction of about 25 to 75, a pore volume of about 25 to 75, or a pore diameter of about 50 nm to 5 microns.

10. The structure of claim 1, wherein the germanium has two or more of the following: a pore fraction of about 25 to 75, a pore volume of about 25 to 75, or a pore diameter of about 50 nm to 5 microns.

11. The structure of claim 1, wherein the germanium has a pore fraction of about 25 to 75, a pore volume of about 25 to 75, and a pore diameter of about 50 nm to 5 microns.

12. A method of making a structure, comprising:
providing a structure having a germanium layer disposed on a substrate; and
forming a porous germanium layer by subjecting the structure to Ge ion implantation.

13. The method of claim 12, wherein the germanium layer is an amorphous germanium layer.

14. The method of claim 12, wherein the germanium layer is a polycrystalline germanium layer.

15. The method of claim 12, wherein the germanium layer is a single crystal germanium layer.

16. The method of claim 12, wherein forming includes using an implant energy of about 100 keV to 300 keV and a dose of about 2 E¹⁵ to 1 E¹⁷ of Ge⁺, wherein the germanium layer has a thickness of about 150 to 250 nm.

17. The method of claim 12, wherein the germanium layer includes silicon.

18. The method of claim 12, wherein the substrate is a material selected from the group consisting of: Al, Ni, Fe, Cu, stainless steel, a non-lithiating metal, and a combination thereof.

19. The method of claim 12, further providing: forming the porous germanium layer so that the porosity extends about 50% or more of the thickness down into the porous germanium layer.

20. The method of claim 12, wherein the porous germanium layer has a capacity of about 1000 milliamp hour/gram of porous germanium or more.

21. The method of claim 12, wherein the porous germanium layer has a coulombic efficiency of about 80-100%.
